(19) United States
(12) Patent Application Publication
(10) Pub. No.: US 2010/0047461 A1
(43) Pub. Date: Feb. 25, 2010

(54) COATED GYPSUM BOARD PRODUCTS AND METHOD OF MANUFACTURE

(75) Inventor: Elizabeth A. Colbert, Newark, DE (US)

Correspondence Address: BUCHANAN, INGERSOLL & ROONEY PC, POST OFFICE BOX 1404, ALEXANDRIA, VA, 22313-1404, US

(73) Assignee: LAFARGE PLATRES, Agroparc (FR)

(21) Appl. No.: 12/610,401

(22) Filed: Nov. 2, 2009

Related U.S. Application Data
(62) Division of application No. 10/625,624, filed on Jul. 24, 2003.
Application No. 10/625,624 is a continuation-in-part of application No. PCT/US02/02106, filed on Jan. 25, 2002.
Application No. 10/625,624 is a continuation-in-part of application No. 10/308,083, filed on Dec. 3, 2002, now abandoned.
Application No. 10/308,083 is a continuation-in-part of application No. 09/633,264, filed on Aug. 4, 2000, now abandoned.
(60) Provisional application No. 60/264,068, filed on Jan. 26, 2001.

(51) Int. Cl. B05D 3/02

(52) U.S. Cl. 427/372.2

(57) ABSTRACT

A method of producing a coated gypsum board includes depositing a gypsum slurry to form a wet gypsum board having a gypsum core; applying a coating to the wet gypsum board; and drying the wet gypsum board, wherein the step of applying the coating occurs prior to the step of drying and the coating penetrates through at least a portion of the facing sheet and into at least a portion of the gypsum core. A board produced by the method is made with a coating that matches a joint compound.

### CROSS-REFERENCE TO RELATED APPLICATIONS

The present application is a continuation-in-part of PCT International Application No. PCT/US02/02106, filed on Jan. 25, 2002, and which designated the United States; the present application also claims the benefit of U.S. Provisional Application No. 60/264,068, filed on Jan. 26, 2001. The present application is also a continuation-in-part of U.S. patent application Ser. No. 10/308,084, filed Dec. 3, 2002, which is a continuation-in-part of U.S. patent application Ser. No. 09/633,264, filed on Aug. 4, 2000, now abandoned. The disclosure of all of the above-referenced applications are hereby incorporated herein by reference.

### BACKGROUND OF THE INVENTION

1. Field of the Invention

The present invention relates generally to coatings for gypsum board products, and the production thereof. More particularly, the present invention relates to the composition of coatings for gypsum board products, and methods of producing the coatings and applying the coatings in one continuous gypsum board manufacturing process.

2. Discussion of Related Arts

In the discussion of the related art that follows, reference is made to certain structures and/or methods. However, the following references should not be construed as an admission that these structures and/or methods constitute prior art. Applicants expressly reserve the right to demonstrate that such structures and/or methods do not qualify as prior art against the present invention, if appropriate.

The product density and surface type and finish of traditional gypsum board products are manufactured to have a desired strength and appearance while minimizing product weight and costs. Generally, calcined gypsum slurry is agitated in a mixer with aqueous foaming agents and deposited onto a conveyor carrying a facing sheet. A backing sheet is applied over the slurry and the wet gypsum board product is formed to the desired thickness between forming rollers. The wet gypsum sets during the conveying process, is cut to the desired length, and is dried by passing the gypsum board product through a drying oven.

Coatings for gypsum board products may be used to impart surface homogeneity and improved surface appearance, both in the manufactured condition and after a decorative coating has been applied. An example of a previously known two-step manufacturing method for coated gypsum board products is disclosed in Australian Patent Application No. 19322/92, the disclosure of which is incorporated herein by reference. A surface coating is applied to the facing sheet and dried before the gypsum is applied to the facing sheet in the gypsum board manufacturing process.

An alternative method for applying a coating utilizes a separate coating process subsequent to the manufacture and drying of the gypsum board product. U.S. Pat. No. 6,105,325, issued to Zuber et al., the disclosure of which is incorporated herein by reference, discloses prefabricated elements, preferably flat prefabricated elements such as gypsum fiberboards, cement fiberboards, cement wallboards or plasterboards, comprising a sheet of lining paper and a plaster body, wherein the structure and/or the external surface of the prefabricated elements is substantially homogenous with the composition of a jointing material, e.g., a sealing coat, a joint coat and/or a joint-pointing coat, in its dry state, to obtain an overall surface having one or more physical characteristics, including color or shade, which are substantially homogeneous in virtually the entire overall surface, including in the region of the visible outer face of the joints.

According to U.S. Pat. No. 6,105,325, in addition to the color or shade, at least any one of the following physical characteristics is substantially homogenized between the flat prefabricated elements and the jointing material, namely: the surface appearance, including reflectance; the absorption of surface water; and decoloration or coloration under the effect of natural light.

In the above processes, the coating imparts desirable aesthetic qualities including surface coloration, reflectance, and absorbency. However, the methods are capital intensive, requiring separate and dedicated production facilities in which to apply the coating and suffering inefficiencies by not being part of a larger in-line production facility.

### OBJECTS AND SUMMARY

It is an object of the present invention to provide an efficient system for manufacturing a gypsum board having a high quality finish.

The present invention provides a coated gypsum board which can be produced in one continuous gypsum board manufacturing process. Such gypsum board can be made either with paper on both sides thereof, paper on one side thereof, or without paper on either side thereof. Further, such gypsum board coatings may be applied to wet gypsum board prior to drying.

In an exemplary embodiment, a coated gypsum board comprises a gypsum core having a first side and second side and a facing sheet disposed on the first side. A coating is disposed on at least a portion of the facing sheet and at least a portion of the coating penetrates into the facing sheet and/or the gypsum core. In an additional embodiment, the gypsum board further comprises a backing sheet on the second side of the gypsum core. In one aspect, the coating may penetrate into the gypsum core to a substantially uniform depth across an area of the gypsum board. A gypsum board with such a coating exhibits a nail pull value of greater than 80 pounds.

In a method of producing a coated gypsum board, a gypsum slurry is deposited to form a wet gypsum board, a coating is applied to the wet gypsum board, and the wet gypsum board is dried. The coating can be applied directly to the gypsum core or to a facing sheet applied over the gypsum slurry. When the coating is applied to the gypsum board prior to drying, the coating can penetrate into the facing sheet and/or the gypsum core and forms a coating that is up to 30 mils in thickness.

In one exemplary embodiment, the coating has a composition of 25-75 vol. % water, 30-70 wt. % calcium carbonate, 0-30 wt. % fillers, 2-10 wt. % latex emulsion, and 0-10 wt. % other additives. Fillers can comprise one or more of mica, talc, clay and limestone. 2-8 wt. % perlite can be added to the coating to form a lightweight product and pigment can also be added in an amount effective to provide a desired tint to the coating.

In a further embodiment, a coating to be applied to a gypsum board has a composition of 10-60 vol. % water, 50-90 vol. % calcined gypsum; 0.1-10 vol. % binder; 0-50 vol. % limestone; 0-10 vol. % clay; 0-30 vol. % other fillers; and 0-10 vol % additives. Fillers can comprise one or more of mica and talc. 2-15 vol. % perlite can be added to the coating to form a lightweight product and pigment can also be added in an amount effective to provide a desired tint to the coating.

In one exemplary embodiment, the coating to be applied to a gypsum board is a joint compound or a diluted joint compound.

An exemplary method of making a wall includes depositing a gypsum slurry to form a wet gypsum board having a gypsum core, applying a coating to the wet gypsum board, and drying the wet gypsum board. The step of applying the coating occurs prior to the step of drying the wet gypsum board. The coated gypsum board is then fastened to a support structure to form the wall and the seams between adjacent coated gypsum boards are taped and finished using a joint compound having a composition substantially similar to the composition of the coating.

### BRIEF DESCRIPTION OF THE DRAWING FIGURES

Aspects and advantages of the invention will become apparent from the following detailed description of preferred embodiments thereof in connection with the accompanying drawings in which like numerals designate like elements and in which:

FIG. 1 is a cross-sectional view of an embodiment of the invention including a coated gypsum board with a coating applied to a facing sheet.

FIG. 2 is a cross-sectional view of an embodiment of the invention including a coated gypsum board with a coating applied to the gypsum core.

FIG. 3 is a schematic of an embodiment of a production line incorporating a coating step prior to drying a gypsum board.

FIG. 4 is a schematic plan view of the coating step showing a coating machine.

### DETAILED DESCRIPTION OF THE PREFERRED EMBODIMENTS

Although the description herein may from time to time refer to a wallboard, a ceiling tile, a ceiling board, or a gypsum board, in each case, the concepts of the present invention may be applied generally to wallboards, ceiling boards, or ceiling tiles.

As used herein, the following physical characteristics are defined as follows:

the reflectance factor of the overall surface, including that of the visible outer face of the joints, is between 70% and 80%, and preferably between 72% and 76%, for a wavelength of 457 nm;
the decoloration or coloration of the overall surface, including that of the visible outer face of the joints, has a color deviation (delta E*) at most equal to 3 after exposure for 72 hours to a source of UV radiation arranged at 15 cm from the surface and having a wavelength at least equal to 290 nm; and
the surface water absorption of the overall surface, including that of the visible outer face of the joints, is not less than 60 minutes.

Generally, gypsum board is installed during construction on surfaces such as wall, ceilings, and the like, in edge abutting engagement. After affixing the gypsum board to the surface with suitable attachments (e.g., nails, screws, epoxy, and so forth), the seams and/or artifacts from the attachments (e.g., depressions from nails, nail heads, screw holes, and so forth) are covered with a coating to present a uniform and smooth finish. For seams, said coatings can be used in combination with tape. The coating material is sometimes referred to as joint compound.

Coatings for use in the gypsum board industry can be of one of two types. In a first type, the coating is applied and the evaporation of water over time produces a hard coating. In a second type, the coating is applied and allowed to set for a suitable time during which the components of the coating solidify into a hard gypsum-based coating.

A coating of either of the first type or the second type can be applied to one side of a gypsum board (e.g., applied to a facing sheet or directly to a gypsum core) during the manufacturing process to form a coated gypsum board. The selection of the coating can be made such that the coating of the coated gypsum board substantially matches the coating or joint compound intended to be used to cover the seams and/or artifacts of attachment associated with the affixing of the coated gypsum board to a structural support. In one embodiment, the coating is a diluted form of the coating or joint compound.

Conventionally, one side of the gypsum or plaster board is covered with a sheet of paper which has a dark color which can vary between a grey color and a chestnut color, since it is composed of cellulose fibers which have not undergone any particular purifying treatment. Traditionally, this so-called grey paper is obtained from unbleached chemical pulp and/or from mechanical pulp, and/or from thermomechanical pulp and/or from semi-chemical pulp. By mechanical pulp, it is usually meant a pulp obtained entirely by mechanical means from various raw materials, essentially wood, which can be provided by salvaged products originating from wood, such as old cardboard boxes, trimmings of kraft paper and/or old newspapers. Thermomechanical pulp means a pulp obtained by thermal treatment followed by a mechanical treatment of the raw material. By semi-chemical pulp is meant a pulp obtained by eliminating some of the non-cellulose components from the raw material by means of chemical treatment and requiring a subsequent mechanical treatment in order to disperse the fibers. As used hereinafter, this type of paper is referred to as grey paper.

The other side of the board is covered with a sheet of paper of a color generally lighter than the grey sheet. To obtain this lighter color, the layer or layers of this face are based on chemical pulp, if appropriately bleached, composed of recycled and/or new cellulose fibers, and/or on mechanical pulp, if appropriately bleached. By chemical pulp is meant a pulp obtained by eliminating a very large proportion of the non-cellulose components from the raw material by chemical treatment, for example, by cooking in the presence of suitable chemical agents, such as soda or bisulphites. When this chemical treatment is completed by bleaching, a large part of the colored substances is eliminated, as well as the substances which risk decomposing by ageing and giving unpleasant yellow shades associated with the presence of, for example, lignin.

Plasterboards similar to Example 5 of document EP-A-0 521 804 are assembled by means of a conventional sealing joint, for example a joint coat sold under the registered trade mark of “PREGYLYS”® of PLATRES LAFARGE. The upper web of the lining of the board is obtained from 65% bleached synthetic cellulose fibers and 35% talcum, and is covered with a pigment layer comprising, as mineral filler, 85% by weight of CaSO₄, 2H₂O in the form of needles of a length of between 3 and 5 μm and, as a binder, 10.3% by weight of styrene-butadiene copolymer.

The sealing joint subsequently receives a thin layer of a joint-pointing coat according to the invention, having the following composition: 50 to 85% by weight of calcium carbonate, grain size from 5 to 35 μm, as a mineral filler; 2 to 12% by weight of a binder comprising polyvinyl acetates and acrylic acid esters in aqueous dispersion; 0.5 to 3% by weight of a silicone derivative as a hydrophobic agent; 0.1 to 0.9% of a cellulose derivative of the methylhydroxyethylcellulose type; 0.1 to 0.6% of a slipping agent of the attapulgite type; 1 to 12% of another silicate derivative as an additional slipping agent; 0.1 to 5% of a polycarboxylic acid ammonium salt as a dispersant; 0.001 to 0.015 of an iron oxide as a pigment; 0.1 to 0.3% of a preparation of N-fonroles and isothiazolinones as a biocide; 0.1 to 0.3% of a conventional anti-foaming agent; water up to 100%.

The weight percentages given are in relation to the total weight of the coat, unless indicated otherwise. For comparison requirements, standard boards conforming solely to French standard NF P 72-302 and not comprising the above-defined upper web and pigment layer are assembled by means of a joint coat for a plasterboard of the range of coats “PREGYLYS”®, sold by the Company PLATRES LAFARGE. The characteristics of the two overall surfaces thus formed are compared by applying the following tests:

(A) Degree of whiteness or reflectance factor R obtained according to standard NFQ 03038 with a wavelength of 457 nm. This degree represents the percentage ratio between of a reflected radiation of the body in question and that of a perfect diffuser under the same conditions.

(B) Surface water absorption: A drop of distilled water of a volume of approximately 0.05 cm³ at 23° C. is deposited on the surface. It is important that the drop be deposited and not allowed to fall from a variable height which consequently would crush it to a greater or lesser extent, thus falsifying the result. The duration in minutes represents the surface absorption of the tested area.

(C) UV radiation resistance obtained by exposing the overall surfaces, in a cabinet comprising eight high pressure mercury vapour lamps, each of 400 watts, to a wavelength which is not less than 290 nm. The surfaces are maintained at a distance of 15 cm from the lamps and at a temperature of 60° C. for 72 hours. The color deviations delta E* are measured on a spectrocolorimeter according to the standard DIN 6174 at an angle of 8.degree., illuminant D65 as a bright specular, included in the system L*, a*, b*, in which L* is the luminance, a* represents the transition from green to red, and b* represents the transition from blue to yellow. A point E* in this system, the said point being a function of L*, a*, b*, defines the colorimetry of a sample and the deviation is measured in relation to a reference point. In general terms, a color deviation beyond 2 becomes discernible to the naked eye.

The results of the tests (A) and (B) are collated in Table I and those of the test (C) are collated in Table II below.

TABLE I

| | | Overall surface according |
|---|---|---|
| | Standard overall surface | to the invention |
| Reflectance R (%) | Board: 50 to 60 | Board: 72 to 76 |
| | Coat: 65 to 85 | Coat: 72 to 76 |
| Absorption (min) | Board: 50 | Board: >=60 |
| | Coat: 15 | Coat: >=60 |

This shows that the overall surface is clearly more homogeneous than that of an assembly according to the conventional technique. Moreover, the more homogeneous absorption time of the overall surface makes it possible to use a paint having less covering capacity than that necessary with traditional boards and coats and is also beneficial to the painting operation.

TABLE II

| | Standard | Invention |
|---|---|---|
| Before Exposure | | |
| Initial Measurements | L* = 82.94 | L* = 90.41 |
| of the board | a* = −0.43 | a* = −0.03 |
| | b* = 4.64 | b* = 3.13 |
| Initial measurements | L* = 90.70 | L* = 89.70 |
| of the joint | a* = 0.73 | a* = 0.50 |
| | b* = 5.28 | b* = 3.60 |
| | Board/Joint color deviation | Board/Joint color |
| | delta E* = 7.87 | deviation delta E* = 1 |
| Exposure to UV for 72 hours | | |
| Measurements of the board | L* = 81.10 | L* = 90.38 |
| after exposure | a* = 0.69 | a* = −0.91 |
| | b* = 12.93 | b* = 7.40 |
| | Color deviation delta E* = | Color deviation delta E* = |
| | 8.56; very substantial | 4.36; substantial |
| | yellowing plus chestnut spots | yellowing |
| Measurements of the | L* = 88.90 | L* = 89.17 |
| joint after exposure | a* = 0.91 | a* = 0.50 |
| | b* = 3.83 | b* = 3.19 |
| | Color deviation delta E* = | Color deviation delta E* = |
| | 2.32; slight yellowing plus a | 0.67; very slight color |
| | few chestnut spots | deviation |

This table shows that the color deviation before exposure to UV is much slighter for an overall surface according to the invention than for an overall surface such as is obtained traditionally.

This table also shows that the change in the color deviation after exposure to UV is much less pronounced in the overall surface according to the invention than traditionally. In fact, the color deviation before exposure and after exposure must be as little as possible, so that the overall surface does not give the impression to the naked eye of being spotted or being covered with zones of different shade and brightness. This is not possible with an overall surface obtained by means of traditional plasterboards and products, but the very slight deviation of the overall surface according to the invention makes it possible to mitigate this disadvantage.

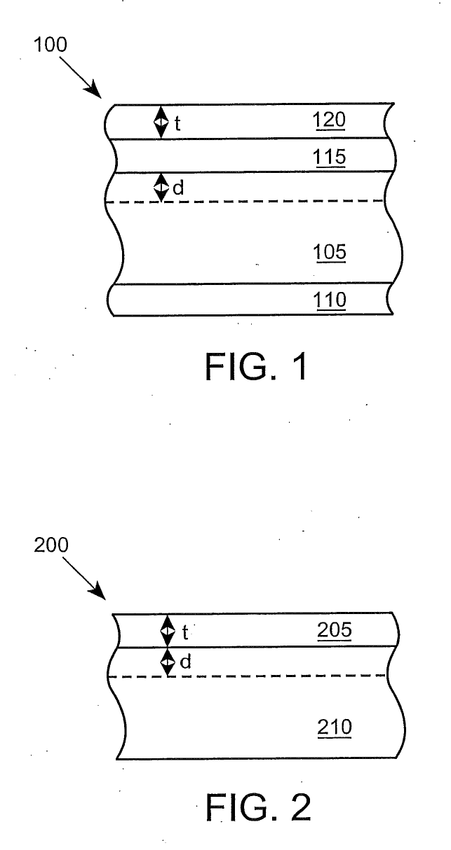

An embodiment of a coated gypsum board 100 is shown in FIG. 1. A gypsum core 105 is disposed between a backing sheet 110 and a facing sheet 115. A coating 120 is disposed on the facing sheet 115. An alternative embodiment of a coated gypsum board 200 is shown in FIG. 2, in which a coating 205 is directly disposed on a gypsum board 210. It should be clear that any combination of facing sheet and backing sheet may be utilized in practicing the invention. In cases where one or more sheets have been removed, the coating may be applied directly to the gypsum core with attendant penetration of the coating into the gypsum core.

The coating is evenly applied onto the surface of the gypsum board (e.g., applied to the facing sheet, if used, or directly to the gypsum core) to a uniform thickness t that is preferably not sensitive to surface irregularities. A typical thickness t for the coating is up to 30 mils, preferably from 3-20 mils, and more preferably from 5-15 mils. The preferred thickness can be dependent on the ultimate application. For example, for wallboards, the thickness t is preferably 10 mils; for ceiling tiles it is 20 mils. Furthermore, thicknesses outside of these ranges may also be contemplated by the present invention. However, a coating of approximately 30 mils or greater may result in cracks and grazing of the surface finish when dried. Accordingly, thicker coatings should be used carefully.

In embodiments in which the gypsum board has a facing sheet, the coating may penetrate into at least a portion of the facing sheet and, in some cases, all the way through the facing sheet and into sections of the gypsum core, over at least a portion of the gypsum board. In one embodiment, the coating may penetrate into the gypsum board over substantially the whole of the area to which it is applied, i.e, the whole gypsum board, or predetermined portions if selected regions of the gypsum board have been coated.

The depth of penetration of the coating can be influenced by the relative moisture level and/or degree of set of the gypsum board, although the coating preferably penetrates into the gypsum board to a substantially uniform depth. In the cross-sectional view as shown in FIG. 1, the coating 120 is shown to have penetrated into the facing sheet 115 and into the gypsum core 110 to a depth d. In other cases, i.e., where the moisture content is lower or the gypsum is in a state of more advanced set, the coating only penetrates a certain depth into the facing sheet. In one embodiment of a gypsum board with a facing sheet, the depth of penetration into the gypsum core is from about 5 mils to 20 mils, preferably from 10 mils to 15 mils. In embodiments of a gypsum board without a facing sheet, the depth of penetration is from about 5 mils to 30 mils, preferably from 10 mils to 20 mils.

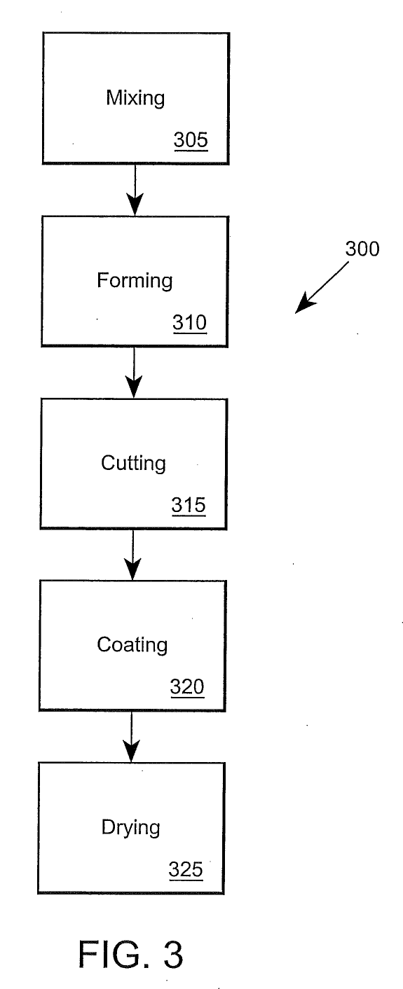

A method of producing a coated gypsum board is shown in FIG. 3, in which a flow chart of a coated gypsum board manufacturing line is depicted. The general manufacturing steps 300 include mixing 305 the gypsum slurry and forming 310 the gypsum into a desired shape, cutting 315 the gypsum into the desired dimensions, followed by coating 320 to form a gypsum board product and then drying 325. Setting of the gypsum occurs primarily between the forming step 310 and the cutting step 315. The manufacturing steps from forming 310 to cutting, inclusive, are herein described as the forming and setting line; the steps following cutting 315 are herein described as the coating and drying line.

Starting at the forming and setting line, a formed, coated gypsum board is manufactured. In a first embodiment, a gypsum core is coated on a first surface with a coating while the gypsum core is wet. In alternative embodiments, the gypsum board has a facing sheet and/or a backing sheet and is coated on a first surface, e.g., on the facing sheet surface, with a coating while the gypsum core is wet. For purposes of this application, a gypsum core is considered wet at any time during the manufacturing process before the gypsum board is passed through the drying oven.

To control the setting time of the gypsum core, the components of the gypsum board can be adjusted, by, for example, controlling the quantity of accelerator and the retarder used in the composition of the gypsum slurry. The accelerator includes small crystal-like objects which are coated with a starch or other dissolvable substances. As the coating on the starch or other dissolvable substances is dissolved, the accelerator crystals form a starting point or seed for crystal growth of the gypsum. Retarder is preferably added to the gypsum board components in order to delay the set time of the gypsum core. The retarder has no long term effect on the strength or other characteristics of the final board product.

It is desirable to delay the set time under certain circumstances so that the gypsum slurry does not set earlier than desired. For example, if the gypsum slurry begins to set in the mixer, inefficiencies result, such as blocked and/or clogged apparatus with attendant down time for maintenance and/or repairs. In addition, if the slurry sets beyond the mixer but prior to forming, forming of the slurry may cause the crystal structure to be disrupted during the setting process, which can result in a weaker final board product. Accordingly, accelerator and retarder may be used singularly or in combination to adjust the set time of the gypsum to achieve a desired set or hardness at a desired time in the manufacturing process.

After forming, the gypsum board is conveyed by a conveying system along the forming and setting line to a cutting position. The conveying speed and distance are chosen in combination with the set time of the gypsum to result in gypsum having a desired set or hardness for subsequent cutting and manipulation. Cutting is accomplished by a cutting machine, as is conventionally known in the art. After being cut, the gypsum board is turned over and placed on a conveying surface and transported to a coating and drying line. Where the gypsum core has a facing and/or backing sheet, the manipulation of the gypsum board results in placing the backing sheet in contact with conveying surface and exposing the facing sheet.

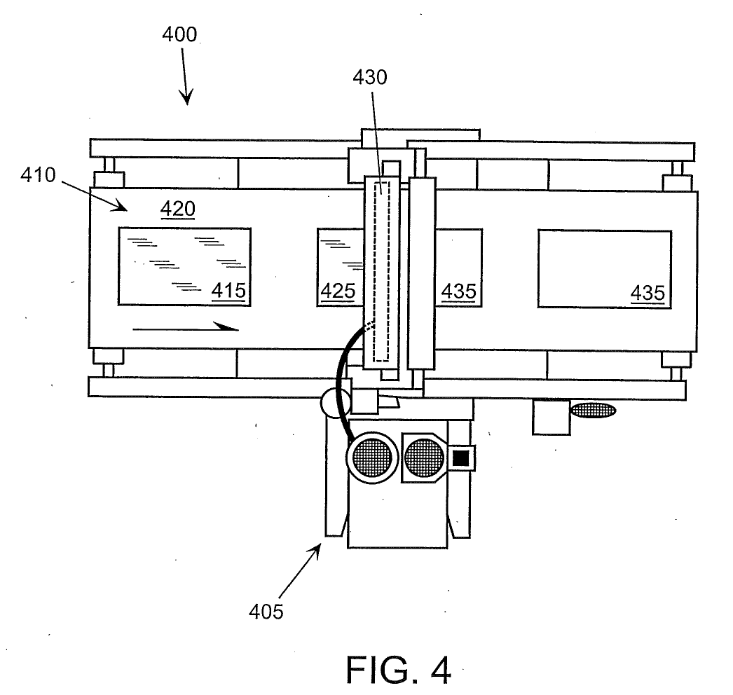

On the coating and drying line, the gypsum board, with or without the facing and/or backing sheet, is conveyed by the conveying means through coating machinery, which is located prior to the drying apparatus. FIG. 4 schematically depicts an in-line coating process 400. The coating machinery 405 is positioned over the conveying path 410 of the gypsum board 415. The conveying path typically includes a conveying belt 420 on which the gypsum board to be coated has been placed, although other suitable conveying paths can be used, such as driven and nondriven rollers. An uncoated and wet gypsum board 425 is passed under the coating machinery 405 and a coating is applied via a coating applicator 430. The coated gypsum board 435 is then conveyed to the next manufacturing steps, if any, and is then dried in, for example, an oven.

The coating can be applied using traditional coating machinery, such as a curtain coater. An example of a curtain coater is that provided by Hymmen International, which can be custom designed to adapt to a particular production line or manufacturing facility. The curtain coater provides a continuous curtain of the coating through which the wet gypsum board is passed. Alternative coating machinery may include sprayers, such as nozzle or shower sprayers, drip lines, and atomization techniques. An example of a spray technology is that provided by Graco, Inc. using spray tips suspended over the wallboard line. Another alternative method is a blade technology that scrapes the coating mix on to the surface of the gypsum board, i.e., on the surface of the gypsum core or the facing sheet. In yet another embodiment, the coating can be applied using one or more rollers.

Coatings may be applied to the gypsum board under any condition of set of the gypsum. For example, the coating can be applied before oven drying, thus allowing the coating to penetrate into the wet facing sheet and/or the wet gypsum core during the conveying period. After coating, the coated gypsum board is dried and then prepared for storage and shipping. Alternatively, the coating can be applied after drying where, for example, the coating is heat sensitive or penetration into the facing sheet is to be minimized.

Coatings can be applied to the whole surface area of the gypsum board, or to predetermined portions thereof. In the latter, predetermined portions can be so designated by, for example, masking the gypsum board to prevent coating of the designated sections or by adjusting the coating machinery to only apply a coating to predetermined portions.

Several alternative embodiments of compositions of coating are envisioned, each affecting the end product. One embodiment of a coating, referred to herein as the “rapid coating”, is a coating that hardens by evaporation of the water content, i.e., a drying coating. The rapid coating comprises water; calcium carbonate; fillers such as limestone, mica, talc, and/or clay; binder; latex emulsion; and other additives such as preservative, and thickener. The rapid coating is provided with a water content of 35-45 wt. % and is diluted in the mixture to between 10% and 60% dilution, e.g., to between 25-70 wt. %, preferably between 39 wt. % and 56 wt. % water, by the addition of water. Table 3 presents an exemplary formulation of an embodiment of the rapid coating.

TABLE 3

| Component | Amount (wt. %) |
|---|---|
| water | 25-75 |
| calcium carbonate | 30-70 |
| mica | 0-10 |
| talc | 0-10 |
| clay | 0-10 |
| latex emulsion | 2-10 |
| other additives | 0-10 |

In a lightweight embodiment of the rapid coating, the filler can include from 2% to 8% by weight perlite. An additional embodiment of the rapid coating incorporates a pigment added in an amount effective to provide a desired tint to the coating. Additionally, the rapid coating may be made so as to substantially match a property of the joint compound, such as the absorbency, the reflectance, and so forth. The substantial homogeneity of one or more properties may improve the aesthetic appearance of the gypsum board in the finished condition after a decorative coating has been applied. In fact, according to one embodiment, the coating applied to the board is actually a diluted form of the joint compound that is used to cover seams between the boards.

Another embodiment of the present invention uses a coating referred to hereinafter as the “setting coating”. The setting coating forms a hard gypsum-based coating by a setting process similar to that of the gypsum in the gypsum board. The setting coating comprises is a dry product comprising calcined gypsum; binder; fillers such as limestone, mica, talc, and/or clay; and other additives such as preservative, accelerator, and thickener. The calcined gypsum may be either alpha or beta type or a blend of these types. Prior to use the setting coating is mixed with 30-60 vol. % water to form a mixture. Table 4 presents an exemplary formulation of a setting coating.

TABLE 4

| Component | Amount (vol. %) |
|---|---|
| Water | 10-60 |
| Calcined gypsum | 50-90 |
| Binder | 0.1-10 |
| Limestone | 0-50 |
| clay | 0-10 |
| Other fillers | 0-30 |
| Other additives | 0-10 |

In a lightweight embodiment of the setting coating, the filler can include from 2% to 15% by volume perlite. An additional embodiment of the setting coating incorporates a pigment added in an amount effective to provide a desired tint to the coating.

The setting coating is generally more resilient to impact, i.e., tougher, than the rapid coating, and may be utilized to provide an abuse resistant surface on the gypsum board, for example, for use in high traffic areas or public spaces. Additionally, the coating may be made so as to substantially match a property of the joint compound, such as the absorbency, the reflectance, and so forth. The substantial matching of one or more properties may improve the aesthetic appearance of the gypsum board in the finished condition after a decorative coating has been applied.

Binders suitable for use in the above rapid coating and setting coating include starches, which assist the binding properties. Examples of such binders are wheat starch which can be preset between 0.01 and 5%.

A preservative suitable for use in the above rapid coating and setting coating can be present between 0.01 and 5%. This additive prevents the product from spoiling prematurely, prior to application. The coatings can spoil because there can exist inside the formulations water and/or a number of organic raw materials. The preservative is also commonly known as the biocide.

Accelerators may be used to adjust the set time in the above setting coating. An example of an accelerator is potassium sulfate. The accelerator can be present in a suitable amount to achieve the desired set time. Typically, the accelerator is present from 0.01 and 15% by solids weight.

Thickeners, such as generic cellulose-based thickeners, may be used to adjust the rheological properties of the coatings and can be present in suitable amounts. Typical values are between 0.01 and 35% by solids weight.

The penetration of the coating provided by the application of coatings to a wet gypsum board results in improved coated gypsum board properties, such as better adhesion of the facing sheet to the gypsum core. In one example, a coating improves board strength, as measured by nail pull. Table 5 includes nail hold values for both coated gypsum board and uncoated gypsum board. From Table 5, it is shown that the coating improves nail pull by up to 25% of nail pull values for traditional uncoated gypsum board products.

TABLE 5

| sample | nail pull value |
|---|---|
| coated | 80 pounds |
| uncoated | 63 pounds |

Additionally, a coated gypsum board displays a mechanical or strength advantage over uncoated gypsum board products that may allow for utilization of facing sheets of lower weight or quality with attendant cost reductions. Typically, facing sheets are anywhere between 40 to 60 lbs. weight. In some applications, the facing sheet is a paper blended with mineral or synthetic fibers. If the facing sheet is to be coated, the improved board strength imparted by the coating allows the paper weight to be reduced. This advantage of the invention is realized while still obtaining the required handling characteristics to allow manipulation without breakage during the manufacturing process. Furthermore, in view of the coating placed therein, the finished side of the board may be made with grey paper, instead of the more expensive bleached paper traditionally used for the finished side.

The Association of Wall and Ceiling Industries International (AWCI), the Ceilings and Interior Systems Construction Association (CISCA), the Gypsum Association (GA), and the Painting and Decorating Contractors of America (PDCA) have defined five levels of gypsum board finish.

The definitions provided for the various finishes are:

### Level 1

A Level 1 finish is recommended in areas that would generally be concealed from view or in areas that are not open to public traffic. In Level 1, “set” has replaced “embedded” so that the first sentence now reads, “All joints and interior angles shall have tape set in joint compound.” This was changed to clarify that tape need not be covered with joint compound to fulfill the requirements of Level 1. In Level 1, the surface is left free of excess joint compound. Ridges and tool marks are acceptable for a Level 1 finish. This level is often specified in the plenum area above ceilings, in attics, or in service corridors.

### Level 2

In garages, warehouse storage areas and other similar areas where the final surface appearance is not of concern, a Level 2 finish is the recommendation. Level 2 may be specified where moisture resistant gypsum board is used as a tile substrate. Level 2 now reads, “All joints and interior angles shall have tape embedded in joint compound and wiped with a joint knife leaving a thin coating of joint compound over all joints and interior angles”. This change is to further differentiate Level 2 from Level 1. Joint compound is applied over all fastener heads and beads. The surface is left free of excess joint compound. Ridges and tool marks are acceptable for a Level 2 finish. Additionally, Level 2 now includes the following sentence: “Joint compound applied over the body of the tape at the time of tape embedment shall be considered a separate coat of joint compound and shall satisfy the conditions of this level.” This sentence also appears in the ASTM C840 Appendix. In the past there has been some confusion as to whether tape pressed into joint compound and covered with joint compound in a single operation fulfilled the requirements of Level 1 or Level 2. This statement is intended to clarify the requirements of Level 2.

### Level 3

In areas to be decorated with a medium or heavy texture or where heavy-grade wall coverings will become the final decoration, a Level 3 finish is recommended. Level 3 now states, “All joints and interior angles have tape embedded in joint compound and one additional coat of joint compound applied over all joints and interior angles. Fastener heads and accessories shall be covered with two separate coats of joint compound. All joint compound shall be smooth and free from tool marks and ridges.” Before final decoration it is recommended that the prepared surface be coated with a drywall primer prior to the application of final finishes. Level 3 is not recommended where smooth painted surfaces or light- to medium-weight wall coverings become the final decoration.

### Level 4

If the final decoration is to be a flat paint, light texture or lightweight wall covering, a Level 4 finish is recommended. Level 4 has been modified to read, “All joints and interior angles have tape embedded in joint compound and two separate coats of joint compound applied over all flat joints and one separate coat of joint compound applied over interior angles. Fastener heads and accessories shall be covered with three separate coats of joint compound. All joint compound shall be smooth and free from tool marks and ridges.” Before final decoration it is recommended that the prepared surface be coated with a drywall primer prior to the application of final finishes. Gloss, semi-gloss and enamel paints are not recommended over a Level 4 finish.

A level 5 finish is defined as follows: “Level 5 finish is recommended for areas where severe lighting conditions exist and areas that are to receive gloss, semi-gloss, enamel or non-textured flat paints. Level 5 requires all the operations in Level 4. Additionally, a thin skim coat of joint compound, or material manufactured especially for this purpose, is applied to the entire surface. (This definition is referenced to Terminology, Section II, Page 2 of GA-214 to make the description of “skim coat” clear to all.) The surface is smooth and free from tool marks and ridges. Before final decoration it's recommended that the prepared surface be coated with a primer prior to the application of final finishes. The Level 5 finish is required to achieve the highest degree of quality by providing a uniform surface and minimizing the possibility of joint photographing and/or fasteners “burning through” the final decoration.”

According to one aspect of the present invention, a level 5 finish can be achieved on a gypsum board during manufacture of the board and prior to installation on a wall. According to another aspect of the present invention, a level 4 finish can be achieved on a gypsum board during manufacture of the board and prior to installation on a wall.

According to yet another aspect of the invention, a wall can be assembled by producing a gypsum board and coating the gypsum board before the drying step with a joint compound or a diluted joint compound. And, when the gypsum board is fastened to a supporting structure to form the wall, the seams between adjacent boards can be taped and finished using a joint compound having a substantially similar or identical composition to the coating. Any of the coatings disclosed herein may be used on embodiments of the present invention.

According to a preferred embodiment, at least one jointing material and at least one skim coat on the board exhibit substantially the same surface water absorbability. Preferably, the at least one jointing material and the at least one skim coat exhibit also substantially the same coloration and/or reflectance factor.

According to a preferred embodiment, the at least one jointing material, e.g. the joint-pointing coat, and the at least one skim coat have substantially the same solids formulation, the skim coat when applied to the board having a solids content lower than the jointing material when applied. Especially, when the skim coat is applied, the viscosity will be adjusted to the viscosity needed for the coating apparatus that will be used.

Compared to the jointing material such as the joint-pointing coat, the skim coat, when applied (for example, when the skim coat is applied to the prefabricated elements, or when the skim coated prefabricated elements are assembled in the methods of the present invention), will comprise more water than initially present in the jointing material such as the joint-pointing coat. It will thus generally comprise additional water, e.g., about 10 to 60%, preferably about 15 to 40%, more preferably about 25%, more water than initially present in the jointing material such as the joint-pointing coat. By “water initially present in the jointing material”, it means the amount of water present in the jointing material when the jointing material is applied to the skim coated prefabricated elements, before the jointing material is in a dry state.

In one embodiment, the final thickness of the skim coat (determined when dry) is generally between about 0.001 and about 3 mm, preferably between about 0.01 and about 2 mm, more preferably between about 0.01 and about 1 mm, and most preferably between about 0.2 and about 1 mm.

According to another preferred embodiment, the jointing material such as the sealing coat, joint coat and/or joint-pointing coat and the skim coat have the following composition, by weight:

40 to 70% of a mineral filler, such as calcium carbonate;
1 to 10% of hydrophobic surface perlite;
0.1 to 10% of a binder such as polyvinyl acetates and acrylic acid esters in aqueous solution;
0.1 to 10% of a handling agent such as a cellulosic ether;
0.1 to 5% of a slipping agent such as clay;
0.1 to 20% of another silicate derivative as an additional slipping agent, such as talc and mica;
water with optional conventional additives up to 100%.
The compositions of the jointing material such as the joint-pointing coat and the skim coat are not limited to the components disclosed above in the above amounts for the preferred embodiment. These components may be present in other amounts in the compositions of the jointing material such as the joint-pointing coat and the skim coat. By using the embodiment involving the skim coat, it is possible to obtain the same surface water absorption, reflectance factor and/or color deviation as with the first embodiment depicted above, i.e. the embodiment involving adapting the composition of the jointing material, e.g. the sealing coat, joint coat and/or joint-pointing coat, to the composition of the surface of the prefabricated elements, e.g. the upper layer or web and/or the pigment layer of the plaster boards, to form a substantially homogeneous outer surface in the dry state.

According to one preferred embodiment, a gypsum board is produced by forming a gypsum slurry and depositing the slurry onto a facing sheet laid out on an endless conveyor belt. A backing sheet is then laid on top of the gypsum slurry. The facing sheet, the gypsum slurry, and the backing sheet are then formed into a wet gypsum board by passing the gypsum and optional facing and backing sheet through a forming roller or rollers to produce the desired thickness. The wet gypsum board is carried by a conveyor belt until a set time expires, after which the gypsum board is cut into desired lengths with a blade cutter, and then passed through a mechanical coater. A subsequent application of heat, such as in a dryer or an oven, removes excess water. At any stage during the process, either the facing sheet or the backing sheet or both may be removed.

In an alternative embodiment of the present invention, the gypsum board product can be formed in a manufacturing line generally known for making ceiling tiles. In such a process, the desired components are blended with a high shear mixer in a batch. The batch is then extruded through an opening of an extruder onto an endless conveyor belt. After a predetermined set time, the mixture is then cut into desired lengths. The cut lengths are then passed through a mechanical coater followed by a dryer to evaporate the excess water.

According to an embodiment of the present invention, lightweight gypsum boards can be made. The density of such boards can range from as low as 1,000 lbs. per thousand square feet to about 1,700 lbs. per thousand square feet, or greater. After cutting the gypsum and while the gypsum is still not dry, the wet gypsum board is transported to the coating and drying line. A coating of thickness of up to 30 mils is applied which is subsequently dried in a drying process, e.g., dried in an oven.

In one preferred embodiment, at least one parameter differs by no more than 10%, preferably no more than 5%, at different parts of the overall surface, so that at least 90%, preferably at least 95%, homogeneity is achieved. In other words, as an example, when said at least one jointing material and the prefabricated elements are dry, said at least one of the parameters of the visible surface of said at least one jointing material can differ by not more than 10%, preferably not more than 5%, from the corresponding parameter of the visible surface of the prefabricated elements.

According to another embodiment of the present invention, a gypsum board product of a desired thickness can be made as conventionally known. For example, a ⅝ inch, ½ inch or ¼ inch gypsum board can be made. After cutting the gypsum and while the board is still not dry, the wet gypsum board is transported to the coating and drying line. A coating of thickness of up to 30 mils is applied which is subsequently dried in a drying process, e.g., dried in an oven.

Although the present invention has been described in connection with preferred embodiments thereof, it will be appreciated by those skilled in the art that additions, deletions, modifications, and substitutions not specifically described may be made without department from the spirit and scope of the invention as defined in the appended claims.

1.-27. (canceled)

28. A method of producing a coated gypsum board, the method comprising:
depositing a gypsum slurry to form a wet gypsum board having a gypsum core, applying a coating to the wet gypsum board; and
drying the wet gypsum board,
wherein the step of applying the coating occurs prior to the step of drying and the coating penetrates through at least a portion of the facing sheet and into at least a portion of the gypsum core.

29. The method of claim 28, wherein the coating is applied directly to the gypsum core.

30. The method of claim 28, wherein the gypsum slurry is deposited onto a facing sheet and wherein the coating is applied to the facing sheet.

31. The method of claim 30, further comprising placing a backing sheet opposite the facing sheet with the gypsum core therebetween.

32. The method of claim 28, wherein the coating is applied during a setting period of the gypsum board.

33. The method of claim 30, wherein the coating is a diluted joint compound.

34. A method of producing a coated gypsum board, the method comprising:
depositing a gypsum slurry to form a wet gypsum board having a gypsum core, applying a coating to the wet gypsum board; and
drying the wet gypsum board,
wherein the step of applying the coating occurs prior to the step of drying and the coating is a diluted joint compound.

35. The method of claim 34, wherein the coating is applied directly to the gypsum core.

36. The method of claim 34, wherein the gypsum slurry is deposited onto a facing sheet and wherein the coating is applied to the facing sheet.

37. The method of claim 36, further comprising placing a backing sheet opposite the facing sheet with the gypsum core therebetween.

38. The method of claim 34, wherein the coating is applied during a setting period of the gypsum board.

39. The method of claim 36, wherein the coating penetrates through at least a portion of the facing sheet and into at least a portion of the gypsum core.

40. A method of producing a coated gypsum board, the method comprising:
depositing a gypsum slurry to form a wet gypsum board having a gypsum core, applying a coating to the wet gypsum board; and
drying the wet gypsum board,
wherein the step of applying the coating occurs prior to the step of drying and coated board has a level 5 finish prior to assembly in its intended use.

41. The method of claim 40, wherein the coating is applied directly to the gypsum core.

42. The method of claim 40, wherein the gypsum slurry is deposited onto a facing sheet and wherein the coating is applied to the facing sheet.

43. The method of claim 42, further comprising a step of placing a backing sheet opposite the facing sheet with the gypsum core therebetween.

44. The method of claim 40, wherein the coating is applied during a setting period of the gypsum board.

45. The method of claim 42, wherein the coating penetrates through at least a portion of the facing sheet and into at least a portion of the gypsum core.

46. The method of claim 42, wherein the coating is a diluted joint compound.

47. A method of producing a coated gypsum board, the method comprising:
depositing a gypsum slurry to form a wet gypsum board having a gypsum core, applying a coating to the wet gypsum board; and
drying the wet gypsum board,
wherein the step of applying the coating occurs prior to the step of drying and the thickness of the coating is up to 30 mils.

48. The method of claim 47, wherein the coating is applied directly to the gypsum core.

49. The method of claim 47, wherein the gypsum slurry is deposited onto a facing sheet and wherein the coating is applied to the facing sheet.

50. The method of claim 49, further comprising placing a backing sheet opposite the facing sheet with the gypsum core therebetween.

51. The method of claim 47, wherein the coating is applied during a setting period of the gypsum board.

52. The method of claim 49, wherein the coating penetrates through at least a portion of the facing sheet and into at least a portion of the gypsum core.

53. The method of claim 49, wherein the coating is a diluted joint compound.
